(19) United States
(12) Patent Application Publication
(10) Pub. No.: US 2004/0189816 A1
(43) Pub. Date: Sep. 30, 2004

(54) Image delivery camera system, image delivery camera, and image delivery server

(76) Inventors: Kenichirou Nakazawa, Nirasaki-shi (JP); Toyoyuki Hara, Yamanashi-ken (JP)

Correspondence Address: KANESAKA AND TAKEUCHI, 1423 Powhatan Street, Alexandria, VA, 22314, US

(21) Appl. No.: 10/736,696

(22) Filed: Dec. 17, 2003

(30) Foreign Application Priority Data
Mar. 24, 2003 (JP) 2003-081283

(51) Int. Cl. H04N 5/232

(52) U.S. Cl. 348/211.2; 348/211.3

(57) ABSTRACT

An image delivery camera system includes a user information terminal; an image delivery camera including a wireless communication unit for performing mobile communication with a base station to send image information to an image delivery server through the wireless communication unit; and an image delivery server for receiving the image information from the image delivery camera and delivering the image information to the user information terminal. In the image delivery camera system, a location of the image delivery camera is determined based on the base station in communication with the wireless communication unit. Information regarding the location of the camera is delivered to the user information terminal together with the image information.

### BACKGROUND OF THE INVENTION AND RELATED ART STATEMENTS

The present invention relates to an image delivery camera system, an image delivery camera, and an image delivery server.

As the information technology has advanced and the communication infrastructure has been expanded, an image delivery technology has been studied and developed in which an electronic camera at a remote location captures an image, and the image is viewed on an information terminal such as a computer or a cellular phone through a network.

Japanese Patent Publication (Kokai) No. 2000-83290 has disclosed an image delivery camera system for delivering image information from a remote place using an Internet Protocol (IP) network such as the Internet. In the system, a location of a camera capturing an image is displayed on a user terminal. Accordingly, an operator (a user) who monitors the displayed image knows the location of the displayed image. When a plurality of cameras is installed, the user may select a location of a desired image among the locations of the displayed cameras.

The image delivery camera system disclosed in Japanese Patent Publication (Kokai) No. 2000-83290 is a system for remote surveillance. Recently, a number of Internet cameras (live camera) have been installed for capturing images at various locations so that many people can watch the images over the Internet. The Internet cameras show locations and shooting directions of the cameras so that a viewer knows where and in which direction the image is captured.

Japanese Patent Publication (Kokai) No. 08-129216 discloses a technique for displaying a location of a camera. In the technique, a global positioning system (GPS) receiver is installed in the camera for sending information with respect to the location, and the information sent from the GPS receiver is presented on a display.

In the conventional techniques described above, when a plurality of cameras is installed for delivering images and it is necessary to change locations of the cameras frequently, it is necessary to perform a complicated process for updating information of the locations and the shooting directions of the cameras. When an Internet camera (live camera) delivers a captured image on a real-time basis and a location of the camera is changed, it is necessary to stop the image delivery until the process for updating a location and a shooting direction of the live camera is completed. The system is difficult to apply to a case in which it is necessary to quickly change a location of a camera and deliver an image.

In the image delivery systems described above, when an image delivery camera is used to deliver an image via wireless communication, as compared with a wired communication system, it is easy to establish a communication line and connect to a network, thereby making it easy to change a location of the camera. For this reason, it is possible to install such an image delivery camera on a vehicle such as a car or an electric train for delivering an image. In this case, when the vehicle with the image delivery camera moves, it is difficult for a viewer of the image to know the location and the shooting direction of the camera.

Japanese Patent Publication (Kokai) No. 8-129216 has disclosed the technique in which a GPS unit is mounted on the camera for sending information regarding the location of the camera. In this technique, it is necessary to install the GPS unit, thereby increasing a cost of the image delivery camera, and making the camera large.

In view of the problems described above, the present invention has been made, and an object of the present invention is to provide an image delivery camera system with a simple configuration in which it is possible to automatically and quickly send information regarding a location and a shooting direction of a camera when the location of the camera is changed.

Further objects and advantages of the invention will be apparent from the following description of the invention.

### SUMMARY OF THE INVENTION

In order to achieve the objects described above, according to a first embodiment of the present invention, an image delivery camera system includes a user information terminal; an image delivery camera including a wireless communication unit for performing mobile communication with a base station to send image information to an image delivery server through the wireless communication unit; and an image delivery server for receiving the image information from the image delivery camera and delivering the image information to the user information terminal. In the image delivery camera system, a location of the image delivery camera is determined based on the base station in communication with the wireless communication unit. Information regarding the location of the camera is delivered to the user information terminal together with the image information.

In the embodiment of the present invention, the user information terminal may be an information processing device capable of receiving the image information such as a personal computer, a cellular phone, a personal data assistant (PDA), and a data communication compatible TV. The wireless communication unit of the image delivery camera may be a device capable of performing the mobile communication with the base station such as a cellular phone, a car telephone, a personal handy-phone system (PHS), and a multi-channel access (MCA) system. The wireless communication unit of the image delivery camera functions as a mobile station in the mobile communication system. In the mobile communication system, a base station in communication with a mobile station can be typically identified. In the present invention, a location of the base station in communication with the mobile station is used as the information regarding the location of the image delivery camera.

In the embodiment of the present invention, the system may be configured such that a shooting direction of the image delivery camera can be changed through a remote control from the user information terminal. It is relatively easy to move the location of the image delivery camera. There is a case that it is necessary to change the shooting direction of the image delivery camera after the camera is moved. In that case, it is possible to change the shooting direction in the remote control. When the image delivery camera is mounted on the vehicle and the vehicle moves, an alignment of the camera is also changed. In that case, a user can change the shooting direction to capture a desired image.

In the embodiment of the present invention, the image delivery camera may include a direction sensor for detecting the shooting direction of the image delivery camera. The information regarding the shooting direction may be sent to the user information terminal together with the information regarding the location of the camera. With this arrangement, the user learns the shooting direction in addition to the location of the image delivery camera, thereby easily recognizing the delivered image and correcting the shooting direction if necessary.

In the embodiment of the present invention, the information regarding the location and the shooting direction of the image delivery camera may be displayed on a map image. With this arrangement, the user can visually recognize and select the shooting direction on the map image. When a plurality of cameras is installed, the user may select one of the cameras while visually monitoring the map. The user thus quickly selects the image delivery camera and a way of shooting the image.

According to a second embodiment of the present invention, an image delivery camera includes an image pickup unit for capturing an image and outputting image information corresponding to the image, an image storage unit for receiving the image information from the image pickup unit and storing the image information, and a wireless communication unit for sending the image information through mobile communication with a base station. A location of the image delivery camera is determined based on the base station in communication with the wireless communication unit.

According to a third embodiment of the present invention, an image delivery server uses an image delivery camera for sending image information through mobile communication with a base station. The image delivery server includes an image information acquisition unit for receiving the image information from the image delivery camera; a position information acquisition unit for acquiring position information representing a location of the image delivery camera based on the base station in communication with the image delivery camera; a position display information acquisition unit for acquiring position display information corresponding to the position information acquired by the position information acquisition unit; and a delivery information generator for generating delivery information containing the image information and the position display information.

### BRIEF DESCRIPTION OF THE DRAWINGS

FIG. 1 is a perspective view showing an image delivery camera according to an embodiment of the present invention;

FIG. 2 is a view showing a state in which the image delivery camera is installed;

FIG. 3 is a block diagram showing a network of an image delivery camera system;

FIG. 4 is a view showing an example of image information and position display information;

FIG. 5 is a block diagram showing the image delivery camera system according to an embodiment of the present invention;

FIG. 6 is a block diagram showing a structure of the image delivery camera;

FIG. 7 is a block diagram showing a structure of an image delivery server;

FIG. 8 is a chart showing a sequence of an operation in which the image delivery camera captures an image and the captured image is displayed on a user information terminal;

FIG. 9 is a view showing an example of a display of the user information terminal;

FIG. 10 is a block diagram showing another structure of an image delivery camera different from that of the image delivery camera shown in FIG. 6;

FIG. 11 is a view showing an example of the information shown on the display of the user information terminal; and

FIG. 12 is an example of the information shown on the display of the user information terminal continued from FIG. 11.

### DETAILED DESCRIPTION OF PREFERRED EMBODIMENTS

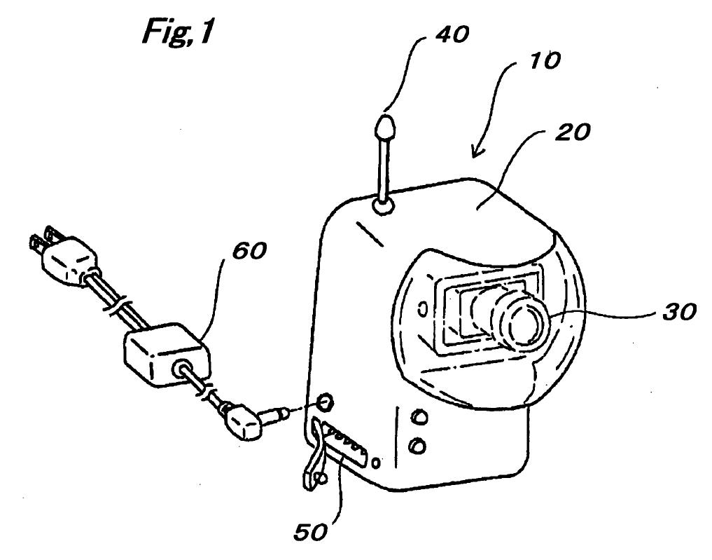

Hereunder, embodiments of the present invention will be explained with reference to the accompanying drawings. According to the present invention, an image delivery system employs an image delivery camera. An outline of the image delivery system will be explained first. FIG. 1 is a perspective view showing an image delivery camera 10.

The image delivery camera 10 includes an external casing 20 and an image pickup unit (camera unit) 30. The image pickup unit 30 is designed to pan and tilt in a shooting operation. A direction sensor (not shown) such as a Hall sensor is mounted in the image pickup unit 30 such that the direction sensor changes the direction together with the image pickup unit 30. The image delivery camera 10 includes a wireless communication unit (not shown) for performing mobile communication. The wireless communication unit sends image data captured by the image pickup unit 30 as image information through a mobile communication network such as a cellular phone network.

The image delivery camera 10 includes an antenna 40 through which the communication unit sends a radio signal to a base station while receiving a radio signal from the base station, and a connector 50 for connecting to a computer. The computer functions as an input device for setting and registering a telephone number in the communication unit. A power cord 60 is connected to the image delivery camera 10 for supplying power.

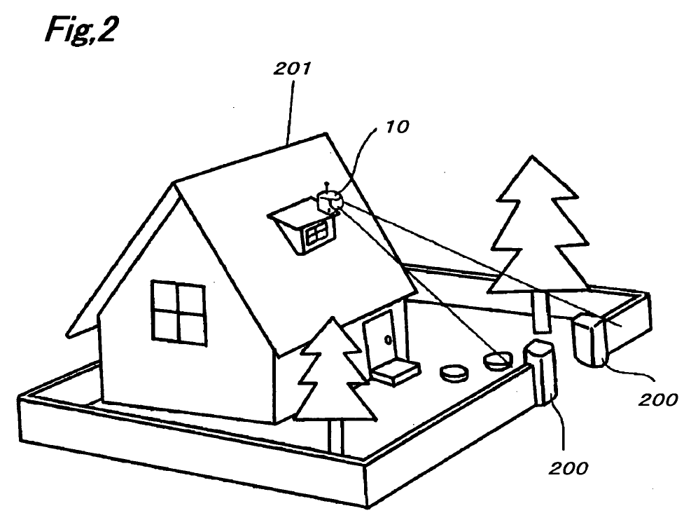

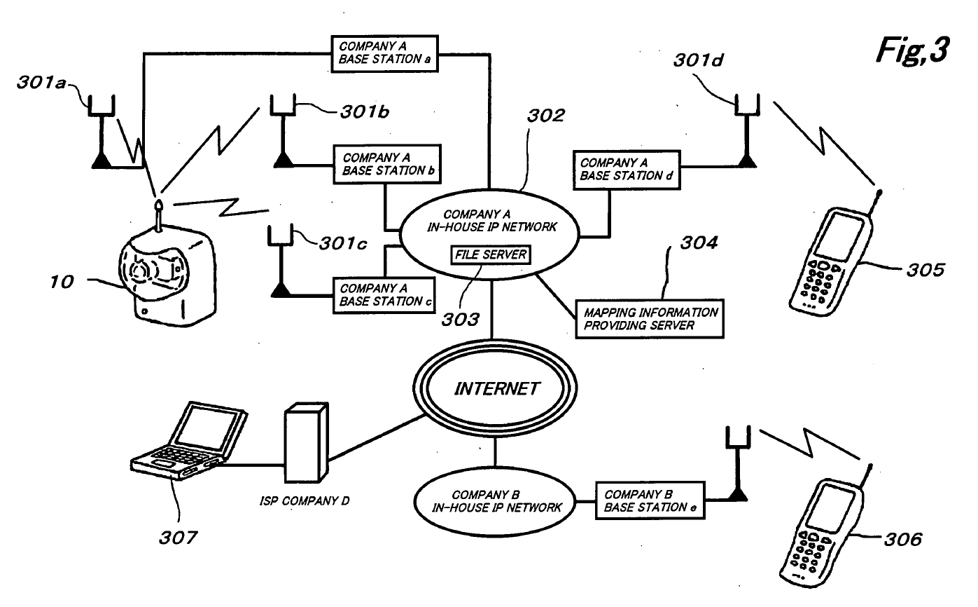

FIG. 2 is a view showing a state wherein the image delivery camera 10 is installed. In this case, the image delivery camera 10 is installed on a house 201, and is aligned with a shooting direction toward a gate 200 and a surrounding area thereof. FIG. 3 is a block diagram showing a network of the image delivery system. The image delivery camera 10 is located within a wireless communication coverage area of an antenna 301c of a base station “c” closest to a location of the image delivery camera 10 among base station antennas 301a, 301b, 301c, and 301d.

When the position information of the image delivery camera 10 is acquired, a base station ID of the base station is identified first. Then, the base station ID is used as a key to inquire the position information from a position information database (not shown) storing the position information corresponding to the base station ID.

There are two methods for acquiring the position information, i.e. a single station method and a multi-station method. In the single station method, an approximate location of a mobile station (wireless communication unit in the image delivery camera 10) is determined from a location of a base station closest to the mobile station. In the multi-station method, a precise location of a mobile station is determined based on base station IDs of a plurality of base stations and electric field intensities of radio signals sent from the base stations. The present invention may use one of the position information acquisition methods.

A company A as a cellular phone telecommunication operator owns an Internet Protocol (IP) network 302 connecting base stations “a”, “b”, “c”, and “d”. A file server (image delivery server) 303 is connected to the IP network 302 for receiving the image information from the image delivery camera 10 and delivering the image information to the user terminal. The image delivery server 303 acquires the position information of the image delivery camera 10 using position information providing service provided by the company A. The image delivery server 303 then transfers the position information to a mapping information providing server 304, and acquires position display information from the mapping information providing server 304.

The “position display information” helps a user to recognize the location of the image delivery camera 10. For example, the position display information may be word information such as “389 Harbor Way, Los Angeles, Calif.” or image information of the location indicated by a pointer on a map image. The position display information is not necessarily visual information delivered to the user. The position display information may be voice data or other data (tactile means using a surface-irregularity of an object).

When the user requests the image delivery server 303 to deliver an image using the cellular phone 305, the image delivery server 303 sends, to the cellular phone 305, the position display information acquired from the mapping information providing server 304 together with the image information acquired from the image delivery camera 10.

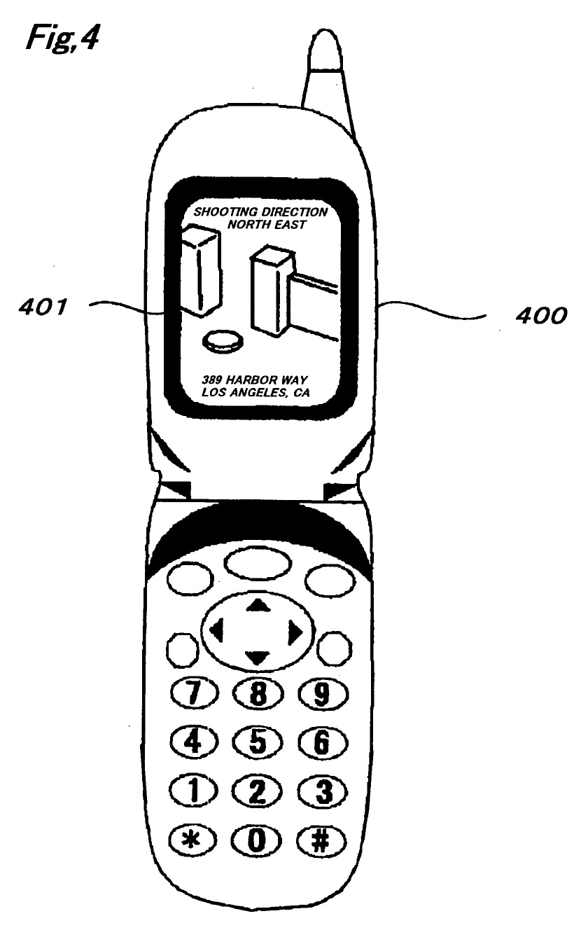

The user views the image information and the position display information presented on a screen of the cellular phone 305, thereby learning where the image is captured. FIG. 4 is a view showing an example of the image information and the position display information. A display 401 of a cellular phone 400 displays the image information, the position display information such as “389 Harbor Way, Los Angeles, Calif.”, and the shooting direction information of “shooting direction at northeast” derived from the direction sensor.

In the embodiment of the present invention, a cellular phone 306 and a personal computer 307 may be connected to another telecommunication operator (here a company B) different from the telecommunication operator used by the image delivery camera 10. It is still possible to receive the image information and the position display information as long as the cellular phone 306 and. the personal computer 307 have access to the image delivery server 303.

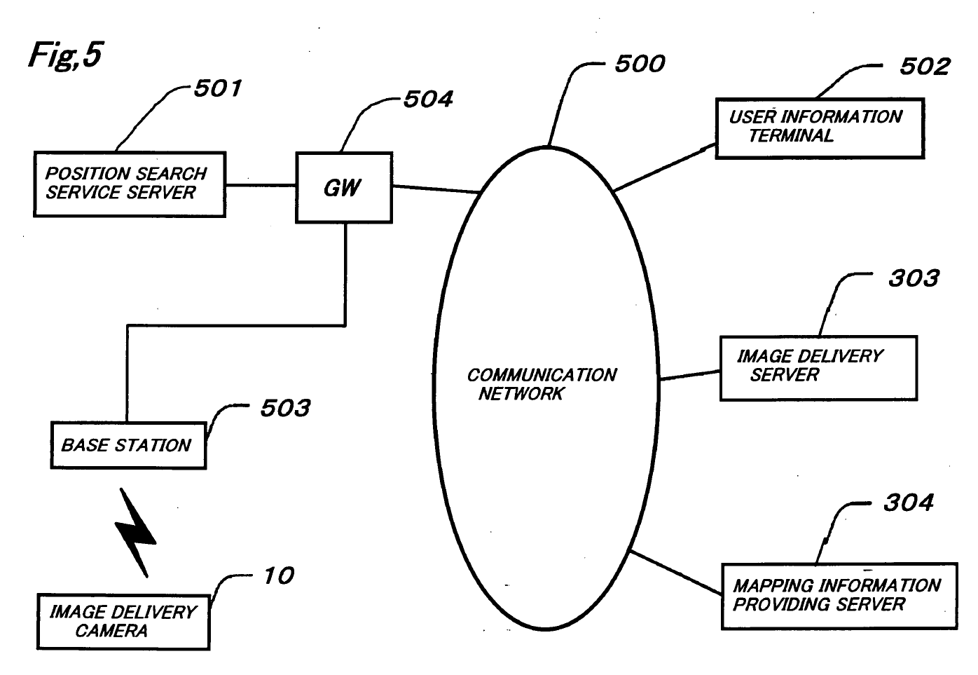

A configuration of the image delivery camera system according to the embodiment of the present invention will be described next. FIG. 5 is a block diagram showing the image delivery camera system. The camera system includes the image delivery camera 10, the image delivery server 303, the mapping information providing server 304, a position search service server 501, and a user information terminal 502. The image delivery camera 10 is linked to the communication network 500 through the base station 503 and the gateway 504. The position search service server 501 is linked to the communication network 500 through the communication network 500. Each of the image delivery server 303 and the mapping information providing server 304 is linked to the communication network 500. The user information terminal 502 is linked to the image delivery server 303 through the communication network 500.

Components of the system will be described next. When a device connected to the communication network 500 establishes a session relative to a target device, the communication network 500 allows the two devices to mutually exchange information regardless of whether the communication network 500 is wired or wireless, or a dedicated line or an exchange line. The communication network 500 may include a plurality of networks interconnected through gateways. It is not necessary to connect with a trunk line called a backbone. For example, the present invention is applied to devices connected to each other on a point-to-point protocol (PPP) basis and exchange information with a session established therebetween. The communication network 500 also includes a communication network of a dedicated fixed line without an exchange device.

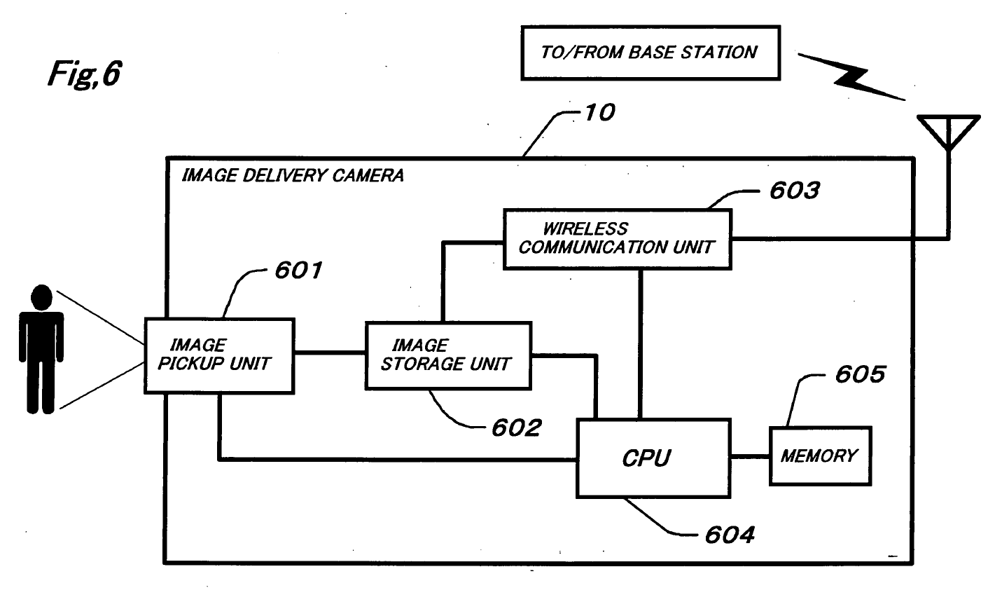

FIG. 6 is a block diagram showing an example of a configuration of the image delivery camera 10. The image delivery camera 10 includes an image pickup unit 601 having an electronic camera; an image storage unit 602 for receiving the image information captured by the image pickup unit 601 and storing the image information; a wireless communication unit 603 for sending the image information stored in the image storage unit 602 through the mobile communication with a base station; a central processing unit (CPU) 604 for controlling the image pickup unit 601 to capture an image and controlling the wireless communication unit 603 to send the image information; and a memory 605 for storing information required by the image delivery camera 10 such as image pickup time, transmission time of the image information, and an address and Uniform Resource Locator (URL) of the image delivery server 303, i.e. a destination of the image information.

The CPU 604 refers to the content of the memory 605, and commands the image pickup unit 601 to capture an image at a predetermined timing, or when the CPU 604 receives an image pickup command from the image delivery server 303. In response to the command, the image pickup unit 601 captures an image, and outputs the image information to be stored in the image storage unit 602. When the image information is stored, the CPU 604 commands the wireless communication unit 603 to send the image information. In response to the command, the wireless communication unit 603 establishes a connection with the base station 503, and sends the image information to the image delivery server 303 through the base station 503.

The image pickup and the transmission of the image may be performed in response to a request from the user information terminal 502. In this case, the wireless communication unit 603 receives the request from the user information terminal 502, and transfers the request to the CPU 604. When the CPU 604 determines that the request is for the image pickup and the transmission of the image, the CPU 604 sends an image pickup command to the image pickup unit 601 and commands the wireless communication unit 603 to send the image information.

The image delivery server 303 includes a central processing unit (CPU), a main memory (RAM), a read-only memory (ROM), an input and output (I/O) unit, and an external storage device such as a hard disk. The image delivery server 303 is an information processing apparatus such as a computer or a workstation. One of the ROM and the hard disk device stores a program for the information processing apparatus to function as the image delivery server 303, or a program for a computer to execute an image delivery method. The image delivery server 303 operates or the image delivery method is performed when the CPU executes the program loaded onto the main memory. The program is not necessarily stored in the memory in the information processing apparatus. For example, the program may be loaded to the main memory from an external apparatus such as an application service provider (ASP).

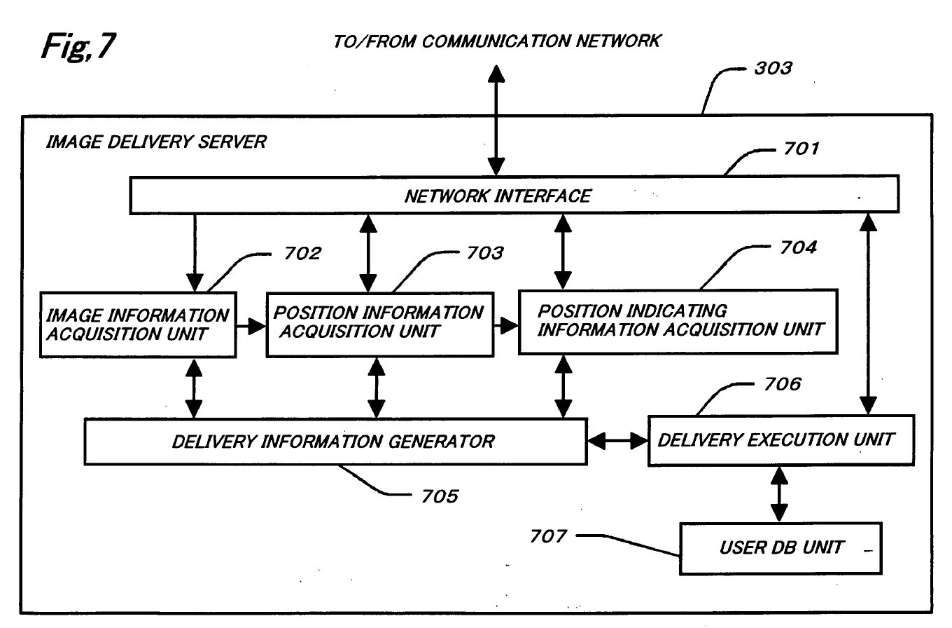

The image delivery server 303 receives the image information from the image delivery camera 10, and sends the position display information indicating the location of the image delivery camera 10 together with the image information to the user information terminal 502. FIG. 7 is a block diagram showing an example of a structure of the image delivery server 303. The image delivery server 303 includes a network interface 701, an image information acquisition unit 702, a position information acquisition unit 703, a position display information acquisition unit 704, a delivery information generator 705, a delivery execution unit 706, and a user Data Base (DB) unit 707.

The network interface 701 receives information from the communication network 500 and sends the information to the communication network 500. The network interface 701 is a front-end communication processor including, for example, a protocol stack and a CPU for performing a predetermined communication procedure in accordance with the protocol stack. The image information acquisition unit 702 receives the image information sent from the image delivery camera 10 through the network interface 701.

The position information acquisition unit 703 receives identification information (CS-ID) of the base station 503 in the communicating state together with the image information sent from the image delivery camera 10. The position information acquisition unit 703 sends the identification information of the base station 503 to the position search service server 501, while receiving the position information indicating the location of the image delivery camera 10 returned from the position search service server 501 in response. The position information is then transferred to the position display information acquisition unit 704.

The position display information acquisition unit 704 sends the position information acquired by the position information acquisition unit 703 to the mapping information providing server 304, and acquires the position display information responsive to the position information.

The delivery information generator 705 receives the image information from the image information acquisition unit 702 while receiving the position display information from the position display information acquisition unit 704 at the same time. The delivery information generator 705 generates delivery information containing the image information and the position display information.

The delivery execution unit 706 sends the delivery information generated by the delivery information generator 705 to the user information terminal 502 through the communication network 500. The delivery execution unit 706 may deliver the image information in a so-called push-type delivery using an electronic mail, or may send the image information in a pull-type delivery in which the image information is sent in response to a request from the user information terminal 502. The position display information is not subject to any limitation in the delivery method for the image information.

The mapping information providing server 304 searches for geographic information such as latitude and longitude coordinates according to the position information, and sends back the geographic information. For example, the mapping information providing server 304 is an electronic map database server. The position search service server 501 searches the location of the image delivery camera 10 as a mobile station, and provides the position information.

The user information terminal 502 is an information processing apparatus capable of being connected to the image delivery server 303 through the communication network 500. The user information terminal 502 may be a cellular phone, a computer having a Web link function and a browser as a Web document viewing software program, a mobile communication terminal, or a personal digital assistant (PDA).

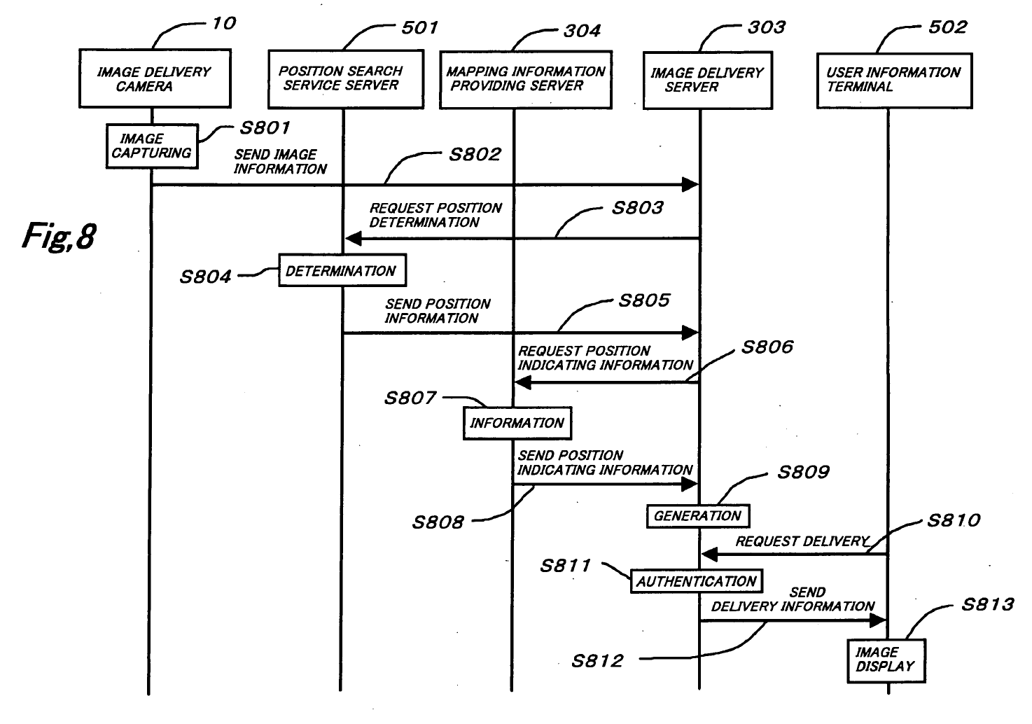

An operation of the image delivery camera system will be described with reference to FIG. 8. FIG. 8 is a sequence of an operation in which the image delivery camera 10 captures an image and the captured image is displayed on a user information terminal 502.

First, the image delivery camera 10 captures the image, and stores the image information of the image (step S801). The image delivery camera 10 sends the image information to the image delivery server 303 through the base station 503 and the communication network 500 (step S802). The image delivery camera 10 sends the identification information of the base station 503 together with the image information.

Upon receiving the image information and the identification information of the base station 503, the image delivery server 303 sends the identification information of the base station 503 to the position search service server 501 to acquire the position information of the image delivery camera 10. The image delivery server 303 thus requests the position information from the position search service server 501 (step S803).

Upon receiving the identification information of the base station 503, the position search service server 501 determines the position information (latitude and longitude information here) corresponding to the identification information of the base station 503 (step S804), and returns the determined position information to the image delivery server 303 (step S805).

The image delivery server 303 sends the position information to the mapping information providing server 304, and requests the mapping information providing server 304 to send the position display information corresponding to the position information (step S806).

Upon receiving the position information, the mapping information providing server 304 searches for and acquires the corresponding position display information, or newly generates the corresponding position display information (step S807). The mapping information providing server 304 sends the position display information to the image delivery server 303 (step S808) The image delivery server 303 generates the delivery information from the position display information and the image information (step S809), and waits for a delivery request from the user information terminal 502.

The user information terminal 502 sends the delivery request for the image information to the image delivery server 303 (step S810). Upon receiving the delivery request, the image delivery server 303 authenticates the user based on the telephone number and the ID of the user information terminal 502 (step S811). When the user is authenticated to be eligible for the service of image delivery (for example, the owner or user of the image delivery camera 10), the delivery information generated in step S809 is sent to the user information terminal 502 (step S812).

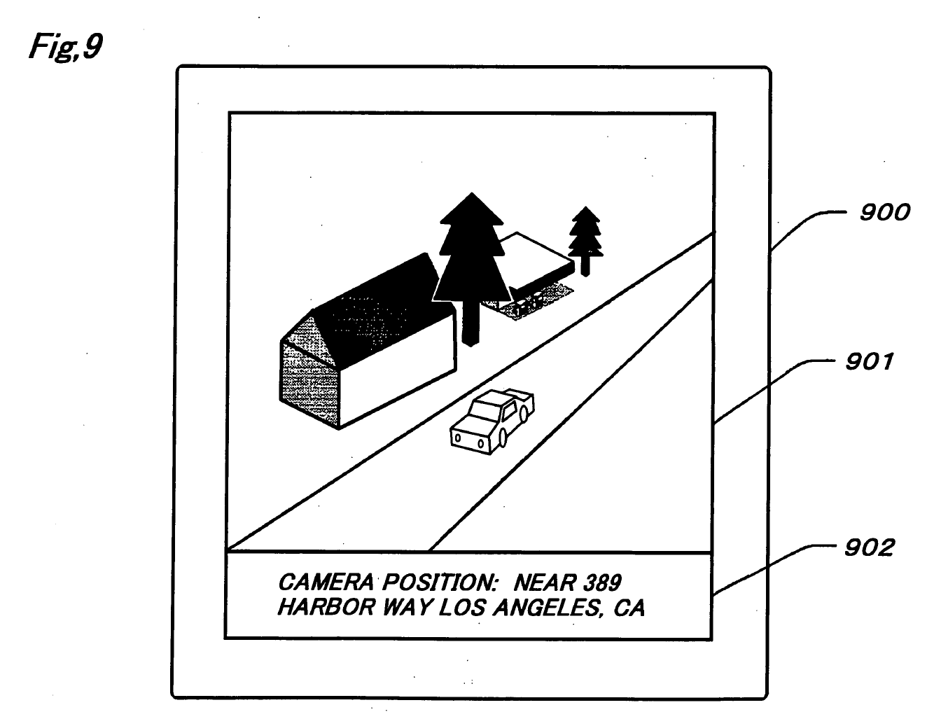

The user information terminal 502 displays the received delivery information on the display thereof (step S813). FIG. 9 is a view showing an example of a display of the user information terminal 502 receiving the delivery information. The image information 901 and the position display information 902 are displayed on the screen, so that the user readily learns the location of the image.

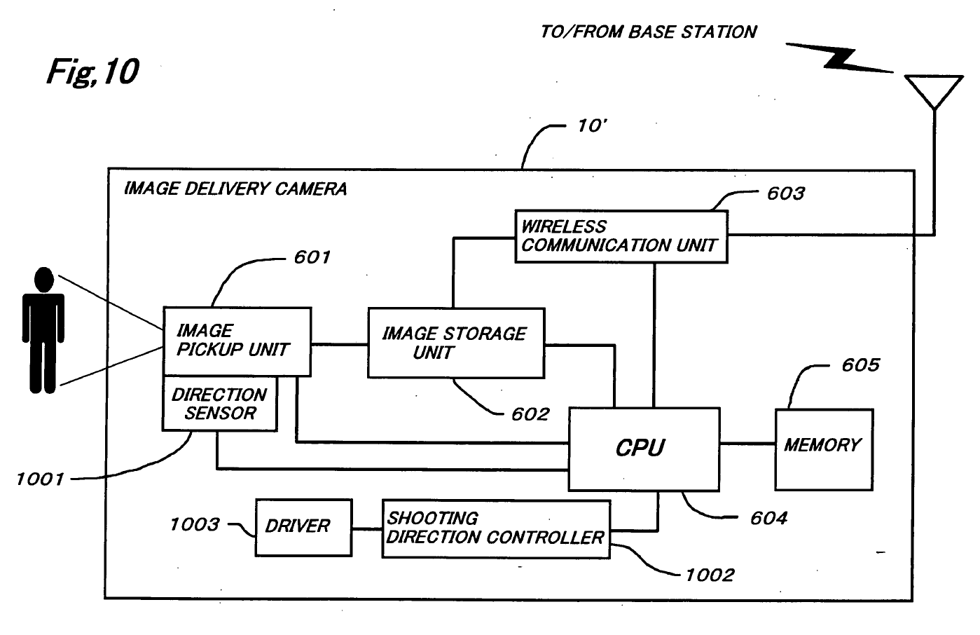

An image delivery camera 10′ having another configuration will be explained next with reference to FIG. 10. FIG. 10 is a block diagram showing a structure of the image delivery camera 10′ different from that of the image delivery camera 10 shown in FIG. 6. The image delivery camera 10′ includes a direction sensor 1001, a shooting direction controller 1002, and a driver 1003. Other features of the image delivery camera 10′ are the same as those of the image delivery camera 10. In FIG. 10, components identical to those shown in FIG. 6 are designated with the same reference numerals, and the descriptions thereof are omitted.

The shooting direction controller 1002 sends a drive command to the driver 1003 in response to a shooting direction change command from the user information terminal 502. The driver 1003 moves the image pickup unit 601 to a specified alignment and a specified shooting direction responsive to the drive command, so that the image delivery camera 10′ changes the shooting direction in response to the command from the user information terminal 502.

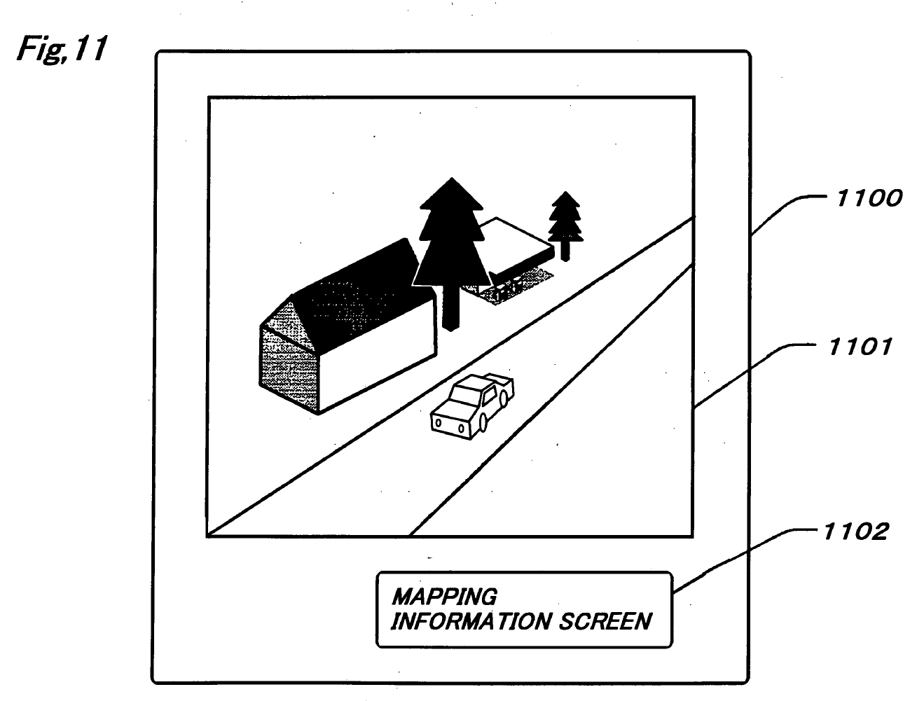

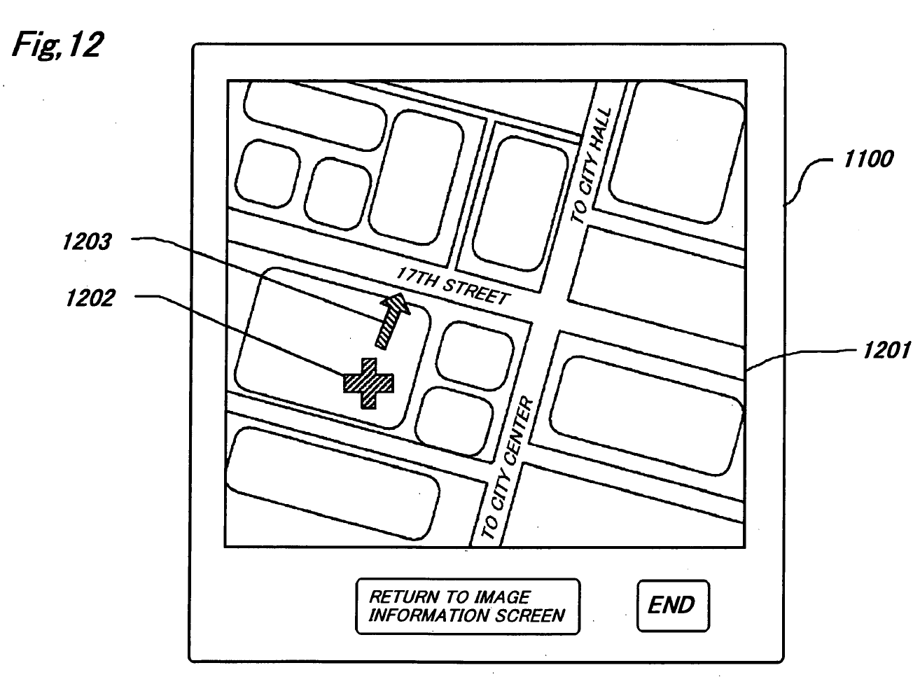

Another example of the position display information provided on the user information terminal 502 will be explained with reference to FIGS. 11 and 12. FIG. 11 is a view illustrating an example of the delivery information presented on a display screen of the user information terminal 502, and FIG. 12 is a view illustrating the example continued from FIG. 11.

As shown in FIG. 11, only image information 1101 is presented on a display 1100. When a user clicks a button 1102 or presses an enter key, the screen is changed to the one shown in FIG. 12. As shown in FIG. 12, a map image 1201 as the image information, a pointer 1202 on the map image, and an arrow 1203 indicating the shooting direction are displayed. The user thus easily learns the location and the shooting direction of the image delivery camera 10.

It is possible to provide a pan and tilt camera with the communication function of PHS, another type of cellular phone, to constitute the image delivery camera 10. The PHS has the following advantages over the other cellular phones.

(1) In the PHS system, base station antennas are densely installed. Accordingly, it is possible to determine a location of the image delivery camera 10 with high accuracy.

(2) The PHS system uses a data rate at 64 Kbps, faster than other types of cellular phones. Accordingly, the PHS system is favorable for transmitting a large amount of data such as image data from the image delivery camera 10.

(3) The PHS system has a large number of underground base station antennas. Accordingly, unlike the GPS system, when the image delivery camera 10 is installed underground within a coverage area of an antenna, it is still possible to determine the location.

In the embodiments of the present invention, it is easy to install the image delivery camera 10. Therefore, there is a concern in which the image delivery camera 10 might be used in a wrong way such as a clandestine shot. However, such a use is restrained because an owner of the telephone number attached to the image delivery camera 10 is easily identified. A telecommunication operator can determine an approximate location of the image delivery camera 10, so that a further restraint effect is expected.

According to the embodiments of the present invention, the image delivery camera system automatically delivers the information concerning the location and the shooting direction of the image delivery camera 10 in an inexpensive manner.

(1) In the conventional image delivery system using the Internet, the camera location is displayed. According to the embodiments of the present invention, the position information of the image delivery camera is automatically updated on a real-time basis even if a location of the image delivery camera moves.

(2) The wireless communication unit sends the image information, and the location of the camera is determined based on the location of the antenna of the base station in communication with the image delivery camera. Accordingly, it is not necessary to install a dedicated device such as the GPS receiver in the image delivery camera for determining the location, thereby reducing a cost and a size of the image delivery camera in the image delivery camera system.

(3) In the embodiments of the present invention, the image delivery camera sends the image information using the wireless communication. Accordingly, it is possible to freely select the location of the image delivery camera. For example, the image delivery camera may be installed on a car or an electric train. It is also easy to install the image delivery camera without routing a communication line, so that the image delivery camera is suitable for mobile applications. The position display information may be information relating to a geographic name selected from the predetermined locations and/or a name of a facility close to the location.

While the invention has been explained with reference to the specific embodiments of the invention, the explanation is illustrative and the invention is limited only by the appended claims.

What is claimed is:

1. An image delivery camera system comprising:
a user terminal for receiving image information and position information,
a base station,
an image delivery camera located away from the user terminal for obtaining the image information and having a wireless communication unit for performing mobile communication with the base station to send the image information,
an image delivery server for receiving the image information from the image delivery camera through the mobile communication and sending the image information to the user terminal, and
means for determining a location of the image delivery camera according to a location of the base station in communication with the wireless communication unit in the image delivery camera to thereby obtain the position information, said position information and said image information being sent to the user terminal.

2. An image delivery camera system according to claim 1, wherein said position information includes a geographic name and a name of a facility close to the location of the image delivery camera.

3. An image delivery camera system according to claim 1, wherein said wireless communication unit includes a cellular phone.

4. An image delivery camera system according to claim 1, wherein said image delivery camera has means to change a shooting direction of the image so that the shooting direction of the image delivery camera can be remotely controlled by the user terminal.

5. An image delivery camera system according to claim 1, wherein said image delivery camera further includes a direction sensor for determining a shooting direction of the image delivery camera to obtain shooting direction information, said shooting direction information being delivered to the image delivery server together with the image information.

6. An image delivery camera system according to claim 5, wherein said user terminal displays the position information and the shooting direction information on a map image.

7. An image delivery camera comprising:
an image pickup unit for capturing an image and sending image information corresponding to the image,
an image storage unit for receiving the image information from the image pickup unit and storing the image information,
a wireless communication unit for sending the image information through mobile communication with a base station, and
means for determining a location of the image delivery camera based on the base station in communication with the wireless communication unit.

8. An image delivery camera according to claim 7, further comprising a driver connected to the image pickup unit for changing a shooting direction of the image pickup unit, and a shooting direction controller connected to the driver for receiving a command from an outside terminal and controlling the driver in response to the command.

9. An image delivery camera according to claim 7, further comprising a direction sensor connected to the image pickup unit for detecting a shooting direction of the image pickup unit and sending shooting direction information, said wireless communication unit sending the shooting direction information together with the image information.

10. An image delivery server using an image delivery camera for sending image information through mobile communication with a base station, comprising:
an image information acquisition unit for receiving the image information from the image delivery camera,
a position information acquisition unit for acquiring position information according to a location of the image delivery camera based on a location of the base station in communication with the image delivery camera,
a position display information acquisition unit for acquiring position display information corresponding to the position information acquired by the position information acquisition unit, and
a delivery information generator for generating delivery information containing the image information and the position display information.

11. An image delivery server according to claim 10, wherein said delivery information generator generates the delivery information containing the position information including a geographic name and a name of a facility close to the location of the image delivery camera.
